(19) United States
(12) Patent Application Publication
(10) Pub. No.: US 2017/0293380 A1
(43) Pub. Date: Oct. 12, 2017

(54) INTERFACE DEVICE WITH A TOUCH SCREEN AND A CONTROL BUTTON

(71) Applicants: Benoit CHAUVEAU, Mery Sur Oise (FR); Oliver Kirsch, Wuppertal (DE)

(72) Inventors: Benoit CHAUVEAU, Mery Sur Oise (FR); Oliver Kirsch, Wuppertal (DE)

(21) Appl. No.: 15/485,875

(22) Filed: Apr. 12, 2017

(30) Foreign Application Priority Data
Apr. 12, 2016 (FR) 1670168

(51) Int. Cl. G06F 3/044; G06F 3/0362

(52) U.S. Cl. CPC G06F 3/044; G06F 3/0362

(57) ABSTRACT

The aspects disclosed herein are directed to an interface device having a touch screen with a two-dimensional array of elementary capacitive detectors formed by a network of electrodes in the form of intersecting bands or by electrodes connected to control or connection lines, being connected to a respective controller. The interface device also includes at least one button with manual activation, and situated on the visible functional surface of the touch screen, and allows viewing through at least one button on the display surface.

### CROSS REFERENCE TO RELATED APPLICATION

This application claims priority to French Patent Application No. 1670168, filed Apr. 12, 2016, entitled “Composite Interface Device with a Touch Screen and a Control Button,” now pending, the entire disclosure of the application being considered part of the disclosure of this application and hereby incorporated by reference.

### BACKGROUND

Many embodiments of devices of the aforementioned type are already known, in particular composite devices comprising both mechanical and electronic controls. Such is the case with the solution proposed by the document U.S. Pat. No. 8,330,713 or by the document EP 2 511 807.

Many of these solutions implement a combined display and controls in the form of a touch screen generally called a “touchpad”. These screens include, in known manner and as shown by FIG. 1, a bidirectional matrix formed either by band-shaped electrodes or by connection lines, arranged in rows Y and columns X. These two series (X, Y) of band electrodes or connection lines define or are connected to active pixels able to detect the contact of the user's finger, for example. The first technology cited above comprises intersecting conductor bands, forming a two-dimensional grid with electrodes formed at the superposed points of intersection. The second technology cited above is based on intersecting control lines connected to point transistors arranged in a two-dimensional array is known to the skilled person as a thin film transistor (TFT) active matrix display. The different techniques cited above (intersecting bands forming electrodes, control lines connected to point transistors) are generally integrated between two glass slabs forming a touch screen and covering the visible face of a liquid crystal display screen (AMLCD/TFT-LCD) or an organic light-emitting diode display screen (AMOLED).

The touchpad technologies mentioned above are known to the skilled person as projected capacitive or surface capacitance technology, comprising as its subcategories the “mutual capacitance” and the “auto-capacitance” technologies.

The bands or lines of each of the two series X, Y of electrodes or lines are connected by a respective collective connection means to at least one contact detection controller, making it possible to locate the place of contact.

In these known embodiments, the mechanical control element, such as a movable, translatory, rotary or segmented button, is maintained on the visible front surface of the panel or pad of the touch screen by magnetic attraction and its position and/or its displacement are registered by sensors located on the opposite rear surface of said panel, as is the electromagnet holding the button and provided with at least one ferromagnetic insert which can be detected by the aforementioned sensors.

It has also been proposed to utilize the transparency properties of the screen in order to transmit light signals through it, which can be registered by an adequate optical sensor located on the rear surface.

Although these known solutions provide satisfaction at least in part, there exists a demand for a more simple and robust fixation of the mechanical means on the screen, while providing physical communication between the two sides of the screen (in particular in the area of the zone receiving the mechanical input). Further, implementers would require an implementation without disturbing the performance or the operating modes of the touch screen (in particular those associated with the two-dimensional arrangement of bands or lines).

### SUMMARY

Accordingly, the disclosure is related to an interface device having a touch screen comprising a two-dimensional array of elementary capacitive detectors formed by a network of electrodes in the form of intersecting bands or by electrodes connected to control or connection lines, all these bands or lines being arranged in rows and columns and being connected to a respective controller, said device likewise comprising at least one button or similar movable mechanical control element, with manual activation, and situated on the visible functional surface of the touch screen, said device being characterized in that, in the area of the zone of location of the button or similar element, the touch screen has at least one through opening or cutout, the button or similar element has at least one means or zone of display or light signaling functionally connected to a power, light, or image supply means through said at least one opening or cutout, and the separated component portions of the bands or lines interrupted by the opening(s) or cutout(s) are all connected electrically to a controller.

### BRIEF DESCRIPTION OF THE DRAWINGS

The invention will be better understood thanks to the following description, involving preferred embodiments, which are given as nonlimiting examples, and explained with reference to the enclosed schematic drawings, in which:

FIG. 1 is a schematic representation of a touch screen integrating a two-dimensional array of banded electrodes, illustrating the negative impact of the making of a through hole in the area of the two-dimensional detection array (see the two rectangles in dotted lines identifying the portions of bands that are not connected);

FIG. 2 is a schematic representation of a touch screen such as that represented in FIG. 1 comprising an improvement according to a first embodiment of the invention, making it possible to overcome the aforementioned negative impact;

FIG. 3 is a partial schematic representation of a touch screen of the prior art in which only the bands of electrodes with horizontal extension and superposed in the vertical direction of the screen (Y series) are represented;

FIG. 4 is a representation similar to that of FIG. 3, illustrating the realization of the continuity of the Y electrode bands in the presence of an opening, and this according to a second embodiment of the invention;

FIG. 5 is a representation similar to that of FIG. 3, illustrating the realization of an electrical connection of all of the electrodes and parts of electrodes in the presence of a through hole, according to a third embodiment of the invention, and

FIGS. 6A and 6B are partial sectional views, in a plane perpendicular to the plane of the screen and containing the axis of rotation of the button, of two variant embodiments of an interface device according to the invention.

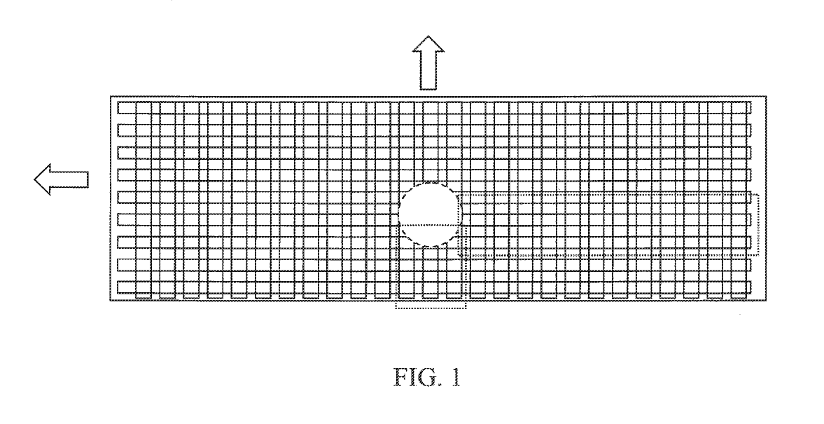

### DETAILED DESCRIPTION

The present disclosure concerns the field of interface devices (man-machine interface) integrating display means and control means, particularly tactile and mechanical ones. The invention preferably deals with devices of the aforementioned type that are intended to be integrated in a dashboard, particularly for a motor vehicle.

The disclosure deals with an interface device comprising a touch screen and a control button or the like.

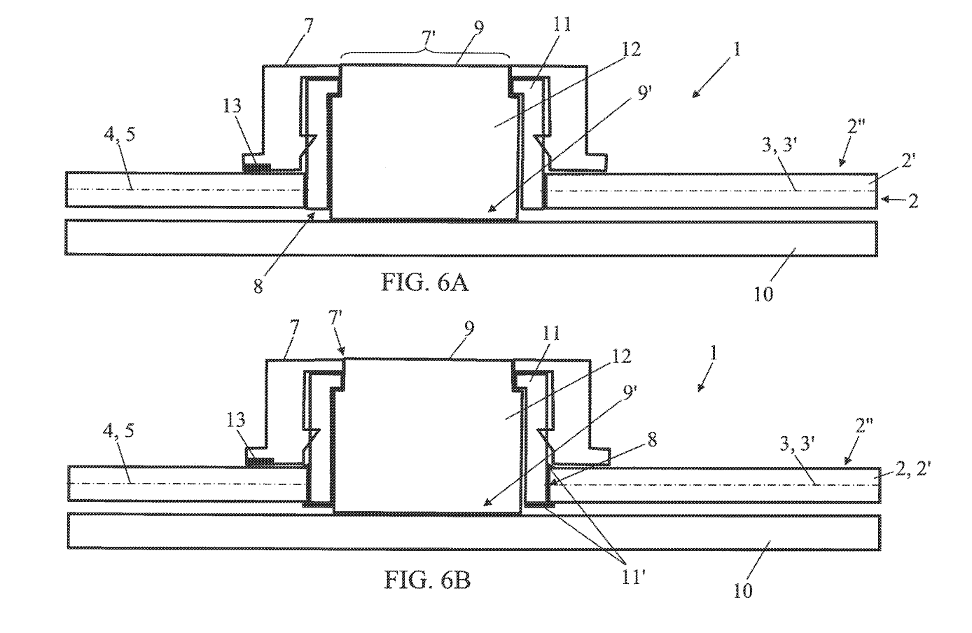

FIGS. 6A and 6B both show an interface device 1 with a touch screen 2 including a two-dimensional array 3 of elementary capacitive detectors 3′ formed by a network of electrodes 4, 5 in the form of intersecting bands or by (local) electrodes connected to control or connection lines, all of these electrodes or lines 4, 5 being arranged in rows and columns and possibly connected to a respective controller 6 (one for the rows and one for the columns). This device 1 likewise comprises at least one button 7 or similar movable mechanical control element, of manual actuation, situated on the visible functional surface 2″ of the touch screen 2.

According to the aspects disclosed herein, in the area of the zone of location of the button or similar element 7 the touch screen 2 has at least one through opening or cutout 8, the button or similar element 7 has at least one zone 9, which is a display or light signaling area connected functionally to a source 10 of power, light, or image supply through said at least one opening or cutout 8, and the separated component portions 4′, 4″; 5′, 5″ of the bands or lines 4; 5 interrupted by the cutout(s) or opening(s) (8) are all connected electrically to a controller 6, either a single one common to them all or one for each set X, Y of parallel and mutually intersecting electrodes or lines 4 and 5.

Thus, by providing a through opening or cutout 8 in the touch screen 2, for example in the form of a sandwich of superposed glass plates enclosing the components of the active or passive detection array, the aspects disclosed herein are able to create a passage enabling physical access to the interior of the button 7.

In particular, the routing of power or light through a physical link enables a visual highlighting of said button 8 or portions thereof, or the visualization of signs, marks, a gradation or other informative or decorative elements on at least a portion of its exterior surface.

Furthermore, by likewise providing a comprehensive connection of all the lines or bands and their portions or fragments resulting from the removal of a part of the body 2′ of the touch screen 2 (in the area of 8), and thus of portions of bands or lines when making the opening or the cutout 8, or each one of the latter, the aspects disclosed herein makes it possible to preserve the original functionality of the touch screen 2 on the entire surface not covered by the button 7 or the like.

According to a preferred embodiment, and as shown for example in FIGS. 6A and 6B, the button or similar movable element 7 is physically connected to a body 2′ in the form of a plate of the touch screen 2, directly or through an intermediate piece 11, in the area of the opening or the cutout 8, while still remaining movable with respect to said screen 2 by rotation or by sliding.

Thus, the aspects disclosed herein opportunely utilizes the opening or cutout 8 as an anchoring site for the button 7 or the like, thus enabling a simple and robust fastening of the latter.

According to a first embodiment, represented in FIGS. 6A and 6B, the button 7 is a rotary button which is mounted with ability to rotate on or in a retention piece 11, which is itself mounted rigidly on or in the opening 8, preferably of circular shape.

According to a second embodiment, not represented in the enclosed drawings, the button 7 is a sliding button which is mounted with ability to slide on or in a retention piece 11, which is itself mounted rigidly on or in the cutout 8, preferably in the form of a slot, preferably forming a guide during the displacement of the button 7.

In the two aforementioned embodiments, the retention piece 11 likewise serves as a guide for the displacement of the button 7 or the like.

This retention piece 11 can be connected rigidly to the touch screen 2, in the area of the edge of the opening or the cutout 8 (FIG. 6A), either by an adhesive bond, or by a mechanical link, for example, with elastic engagement by fins or notches 11′ (FIG. 6B), or by a combination of these two fastening techniques.

According to one advantage of the aspects disclosed herein, said at least one connection 12 connecting the zone 9 of display or signaling to the distant power supply 10 passing through the opening or the cutout 8 consists of at least one optical or electrical conductor. The connection 12 can be capable of a bidirectional transmission and may optionally integrate conductors of different kind.

When the desired purpose is to make the button 7 more evident (and manipulable) in the dark, or to use it as a display surface, at least two technical solutions may be contemplated, namely, either to integrate the display or light production in the button 7 and to power t by electrical lines 12, connected to a controlled source 10, or to provide optical transmission, such as one or more optical fiber(s), diffusing in the area of the button 7 the images or the light produced at a distance for a controlled source 10.

According to a preferred variant embodiment of the invention, and as shown by FIGS. 6A and 6B, the button 7 is a cylindrical rotary button mounted on a holding piece 11 in the form of a sleeve and secured in the opening 8, said holding piece 11 forming a passage and holding for the connection 12 connecting the zone 9 of display or signaling to the power supply 10.

In particular, in the context of the aforementioned variant, the embodiment can have a button 7 include at least one transparent or translucent wall portion or a cutout 7′ with a zone of display or signaling 9 corresponding to the exit end of a bundle of optical fibers 12, the opposite end 9′ of this bundle 12 being connected to the supply 10 and said bundle of optical fibers 12 extending through the opening 8 in the touch screen 2 and being held by an intermediate retention piece 11 mounted rigidly in said opening 8, on or around which said button 7 is mounted with ability to rotate.

The supply 10 able to provide light or images (stationary or moving) and can include, for example, of a portion of an organic liquid crystal or LED display screen, furnishing the image displayed on the touch screen 2 and having one diffuse emitting zone in the end 9′ of the bundle of optical fibers 12.

In order to identify the position and/or the displacement of the button 7 or the like, it may be provided that the latter is provided with at least one conducting (index forming) portion or zone 13 which is situated in immediate proximity to the surface of the visible functional face 2″ of the touch screen 2, the position of said at least one conductive portion or zone 13 being detected by detectors 2′ of the network of elementary capacitive detectors 2′ located beneath and/or around the base of the button 7 or the like. Thus, as the button 7 rotates, the capacitive detectors 2′ detect movement via the at least one conductive portion or zone 13 beneath and/or around the base of button 7.

Optionally, at least one zone of the button 7 can be of touch type, and the detection signals of a contact can be transmitted by the means 12 and processed at a distance by an adapted controller (not shown).

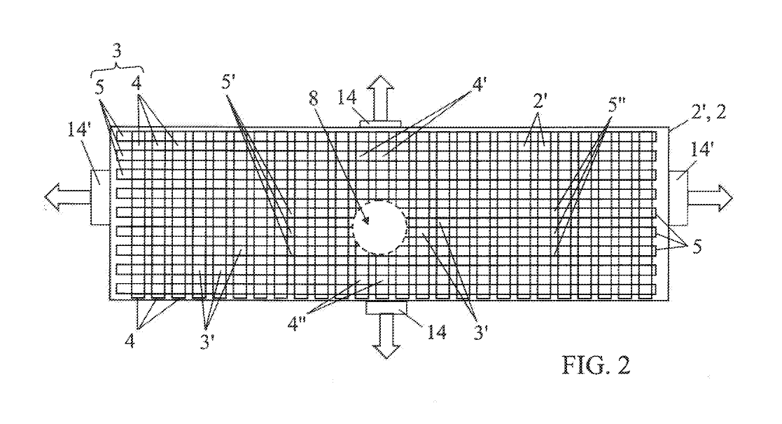

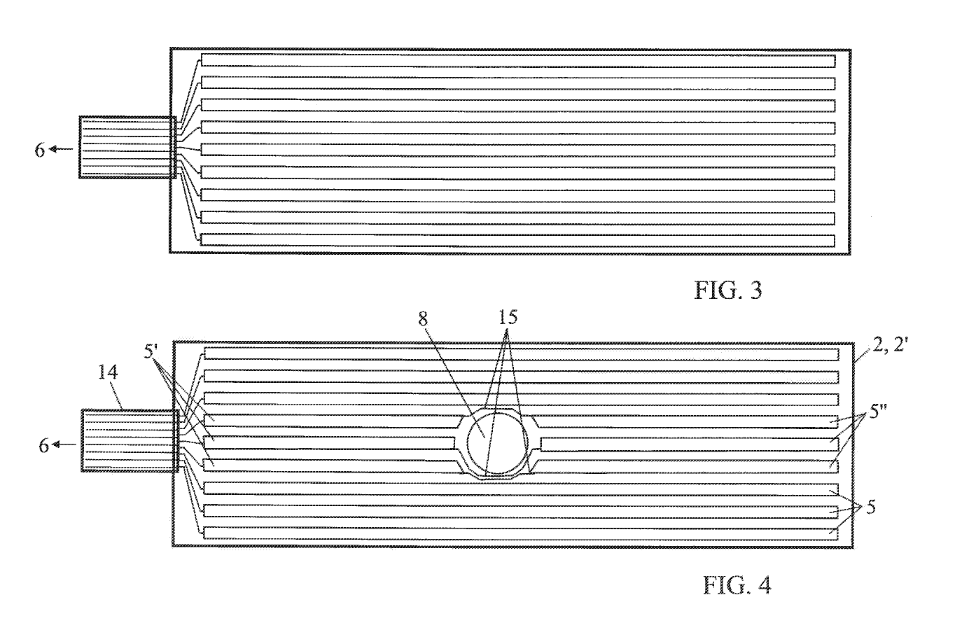

As illustrated by nonlimiting examples in the enclosed FIGS. 2, 4 and 5, various technical solutions can be contemplated for connecting the group of remaining elementary sensors 3′ and thus exploiting to the maximum the surface of the touch screen 2 not affected by the presence of the button 7.

According to a first variant embodiment shown in FIG. 2, it may be provided that all the sides of the touch screen 2 (for in the case of a square or rectangular screen) are each connected to a common controller 6 or their own controller.

According to a second variant shown in FIG. 4, the bands or lines 4, 5 of each set of electrodes or lines X, Y are connected to a single respective connection terminal 14, 14′ situated on a given side of the body 2′ in the form of a plate of the touch screen 2, the separated component portions 4′; 5′ located opposite the corresponding respective terminal in relation to the opening or the cutout 8 being connected to their complementary portions 4′; 5′ respectively corresponding and situated on the same side as the particular terminal 14 by conducting lines 15 surrounding said cutout or said opening 8 and preferably situated in the same plane as the respectively involved control lines or electrodes in the form of bands 4, 5.

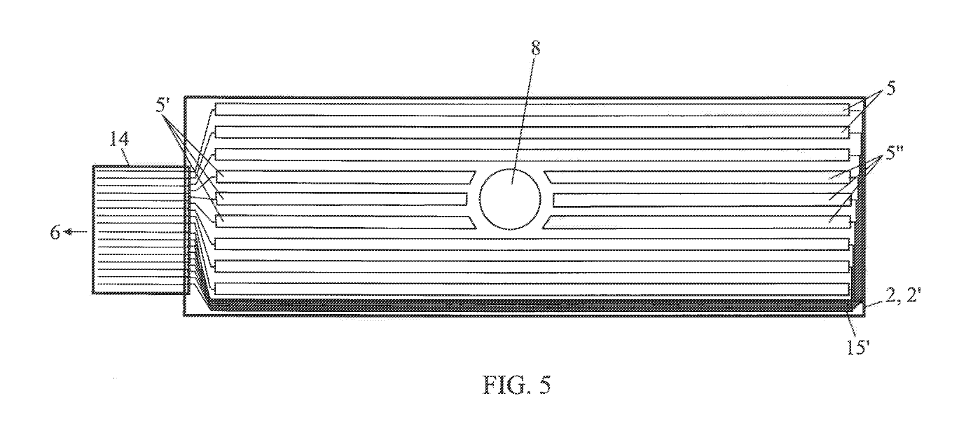

According to a third variant shown in FIG. 5, the bands or lines 4, 5 of each set of electrodes or lines X, Y are connected to a single respective connection terminal 14 situated on a given side of the body 2′ in the form of a plate of the touch screen 2, the separated component portions 4′ and 5′ located opposite the corresponding respective terminal in relation to the opening or the cutout 8 being connected to their complementary portions 4′; 5′ respectively corresponding and situated on the same side as the particular terminal 14 by conducting lines 15′ extending along the peripheral edges concerned of the body 2′ of the touch screen 2, and preferably situated in the same plane as the respectively involved control lines or electrodes in the form of bands 4, 5.

Of course, the aspects disclosed herein are not limited to the embodiments described and represented in the enclosed drawings. Modifications remain possible, especially from the standpoint of the formation of the various elements or by substitution of technical equivalents, without thereby leaving the realm of protection of the invention.

What is claimed is:

1. An interface device having a touch screen, comprising:
a two-dimensional array of elementary capacitive detectors formed by a network of electrodes in the form of intersecting bands or by electrodes connected to connection lines, the intersecting bands or the connection lines being arranged in rows and columns and being connected to a respective controller,
at least one movable mechanical control element, with manual activation, and situated on a visible functional surface of the touch screen,
wherein in an area of the at least one moveable mechanical control element, the touch screen having at least one through opening, the area being a display or light signaling functionally connected to a power, light, or image supply through the at least one opening, and a separated portion of the intersecting bands or the connection lines defined by the opening, are connected electrically to a controller.

2. The interface device according to claim 1, wherein the at least one movable element is physically connected to a body of the touch screen, directly or through an intermediate piece in the area, while still remaining movable with respect to the touch screen by rotation or by sliding.

3. The interface device according to claim 1, wherein the movable mechanical control element is a rotary button that rotates on or in a retention piece, the retention piece being mounted rigidly on or in the at least one opening.

4. The interface device according to claim 1, wherein the movable mechanical control element is a sliding button which is mounted with ability to slide on or in a retention piece, the retention piece being mounted rigidly on or in the at least one opening.

5. The interface device according to claim 1, wherein the area is coupled to the power, light, or image supply via an one optical or electrical conductor.

6. The interface device according to claim 1, wherein the movable mechanical control element is a cylindrical rotary button mounted on a holding piece in the form of a sleeve and secured in the opening, the holding piece forming a passage connecting the area signaling to the power, light, or image supply.

7. The interface device according to claim 1, wherein the moveable mechanical control element includes at least one transparent or translucent wall portion, and the area corresponds to an exit end of a bundle of optical fibers, an opposite end of the bundle being connected to the light or image supply,
and the bundle extending through the opening in the touch screen and being held by an intermediate retention piece mounted rigidly in the opening, on or around the moveable mechanical control element.

8. The interface device according to claim 1, wherein the moveable mechanical control element is provided with at least one conducting portion which is situated in immediate proximity to the surface of a visible functional face of the touch screen, the position of the at least one conductive portion being detected by a capacitive element of the touch screen located beneath or around a base of the moveable mechanical control element.

9. The interface device according to claim 1, wherein the bands or lines of each set of electrodes are connected to a single respective connection terminal situated on a side of the body in a form of a plate of the touch screen, and
a separated component portions located opposite a corresponding respective bands or lines in relation to the opening, being connected via a conducting lines surrounding the opening.

10. The interface device according to claim 1, wherein the bands or lines of each set of electrodes are connected to a single respective connection terminal situated on a side of the body in a form of a plate of the touch screen, and
a separated component portions located opposite a corresponding respective bands or lines in relation to the opening, being connected by conducting lines extending along a peripheral edge of a body of the touch screen.
